(19) United States
(12) Patent Application Publication
(10) Pub. No.: US 2026/0330015 A1
(43) Pub. Date: Oct. 22, 2026

(54) HYPERDIMENSIONAL MALWARE CLASSIFICATION AND RESPONSE

(71) Applicant: Open Text Inc., Menlo Park, CA (US)

(72) Inventors: Bhaskar Rao, Vadodara (IN); Aniket Kumar, Patna (IN)

(21) Appl. No.: 19/182,376

(22) Filed: Apr. 17, 2025

(51) Int. Cl. G06F 21/56; G06F 21/55

(52) U.S. Cl. CPC G06F 21/56; G06F 21/554; G06F 2221/033

(57) ABSTRACT

Embodiments include hyperdimensional computing (HDC) malware classification systems and methods. An input, such as a classification request or search request, for processing using hyperdimensional computing malware classification can be received and a plurality of features extracted for the input. For example, if the input indicates an object, such as a file to be classified, detection features can be extracted for the object. If the input includes a search query, search features can be extracted. A new hyperdimensional vector can be generated using the features and evaluated using a hyperdimensional hash table to identify a responsive malware category for the input. The hyperdimensional hash table may be based on a collection of data comprising known samples of malware from a plurality of malware categories. The responsive category may be used, for example, to classify a malware sample or as a relevant category for a search query.

### TECHNICAL FIELD

Embodiments of the present disclosure relate to classifying and remediating cybersecurity threats. Even more particularly, embodiments of the present disclosure relate hyperdimensional computing classifiers for malware classification and response.

### BACKGROUND

Traditional virus classification techniques often rely on linear or binary matching algorithms, which are not well-suited for handling large-scale data streams or adapting to new threats in real-time. For example, linear or binary matching to known malware signatures struggles with obfuscated and polymorphic threats.

Some threat detection platforms use machine learning techniques, such as deep neural networks and support vector machines, to detect malware and update detection models. While such techniques can identify new threats, these solutions are resource intensive and data sensitive and have difficulty efficiently processing and analyzing large volumes of data, especially in high-traffic environments. As such, they are often not suitable for real time detection of malware. Additionally, retraining the classification model is a time consuming and resource intensive task that does not occur in real-time and often involves processing the same training data through multiple iterations.

Moreover, traditional malware classification techniques and existing machine learning classifiers do not provide actionable remediations. As such, there is often a significant remediation gap between detection of threat and the determination of the appropriate remediation for the threat.

### SUMMARY

One example embodiment includes a computer-implemented method for malware remediation. Embodiments also include related non-transitory, computer-readable media and systems to implement the method. The method may include receiving an input to be processed using hyperdimensional computing malware classification and extracting a plurality of features based on the input. For example, if the input indicates an object, such as a file to be classified, detection features can be extracted for the object. If the input includes a search query, search features can be extracted.

The method can further include generating a new hyperdimensional vector that represents the plurality of features. For example, a sample hyperdimensional vector representing a sample to be classified or a search hyperdimensional vector representing a search can be generated.

Embodiments may further include evaluating the new hyperdimensional vector using a hyperdimensional hash table comprising a plurality of malware category classification hyperdimensional vectors to identify a responsive malware category for the input. The plurality of malware category classification hyperdimensional vectors may be based on a collection of data comprising known samples of malware from a plurality of malware categories. The responsive category may be used to classify a sample or returned as a malware category that is relevant to a search query. According to one embodiment, the responsive malware category comprises at least one of the following: a most similar malware category, a top x similar malware category determined for the input, a k-nearest neighbor malware category determined for the input, or a geographic nearest neighbor malware category determined for the input.

Another embodiment includes a non-transitory, computer-readable medium storing thereon software code, where the software code comprising instructions translatable by a processor by to extract a plurality of detection features for an object, such as a file, to be classified, generate a sample hyperdimensional vector that represents the plurality of detection features extracted for the object; and evaluate the sample hyperdimensional vector using a hyperdimensional hash table to classify the object according to a malware type. The hyperdimensional hash table may comprise a plurality of malware category classification hyperdimensional vectors, where the plurality of malware category classification hyperdimensional vectors may be based on a collection of data comprising known samples of malware from a plurality of malware categories.

Another embodiment includes a hyperdimensional computing system. The hyperdimensional computing system includes a processor, a memory configured to store a hyperdimensional hash table, and a non-transitory, computer-readable medium comprising software code translatable by the processor to provide a hyperdimensional malware classification system. The hyperdimensional hash table comprises a plurality of malware category classification hyperdimensional vectors, which may be based on a collection of data comprising known samples of malware from a plurality of malware categories.

According to one embodiment, the hyperdimensional malware classification system comprises a hyperdimensional vector generator executable to encode features as new hyperdimensional vectors, a feature extractor executable to extract detection features for files to be classified and provide the detection features the hyperdimensional vector generator, a search handler executable to extract search features from search queries and provide the search features the hyperdimensional vector generator and a hyperdimensional malware classifier executable to evaluate the new hyperdimensional vectors using the hyperdimensional hash table to classify the files and identify malware categories relevant to the search queries. In some embodiments, the hyperdimensional malware classification system comprises a remediation mapper executable to determine recommended remediations for the files and recommended remediations responsive to the search queries.

According to one embodiment, an HDC malware classifier can implement continuous automated learning to update the hyperdimensional hash table to detect polymorphic malware as the polymorphic malware evolves. For example, the classifier can determine the similarity of the responsive category meets a similarity threshold for learning and based on a determination that the similarity of the responsive category meets the similarity threshold, incorporate the new hyperdimensional vector into the malware category classification hyperdimensional vector corresponding to the most similar malware category.

In some embodiments, the input processed by the HDC malware classification system comprises a request to classify an object. Accordingly, embodiments may include classifying an object, such as a file, as a malware type according to the responsive malware category determined for the input. In addition, or in the alternative, to the input including a request to classify an object, the input processed by the HDC malware classification system may include a search query. As such, the responsive malware category may be a malware category determined to be relevant to the search query.

According to one embodiment, evaluating a new hyperdimensional vector using the hyperdimensional hash table to identify a responsive malware category comprises determining a similarity of the new hyperdimensional vector to each of the plurality of malware category classification hyperdimensional vectors and identifying the most similar malware category for the new hyperdimensional vector. The most similar malware category corresponds to a malware category classification hyperdimensional vector, from the plurality of malware category classification hyperdimensional vectors, that has the highest similarity to the new hyperdimensional vector. In some embodiments, the HDC malware classifier classifies an object of interest according to the most similar malware category determined for the object.

Embodiments may include determining that the similarity of the most similar malware category meets a similarity threshold for learning and, based on the determination that the similarity of the most similar malware category meets the similarity threshold, incorporating the new hyperdimensional vector into the malware category classification hyperdimensional vector corresponding to the most similar malware category.

Some embodiments include determining a recommended remediation associated with the responsive malware category and returning the responsive malware category and recommended remediation to a requestor. In some embodiments, the recommended remediation is automatically executable by a requesting system. Determining the recommended remediation may comprise, in some embodiments, determining a remediation mapped to one or more of the following: a most similar malware category, a top x most similar malware category, a k-nearest neighbor malware category, a geographic nearest neighbor malware category.

In some embodiments, the hyperdimensional hash table comprises a plurality of category remediation hyperdimensional vectors based on remediations associated with malware categories from the plurality of malware categories. Determining the recommended remediation may include generating a possible remediation hyperdimensional vector from the possible remediation and determining a similarity of the possible remediation hyperdimensional vector to a category remediation hyperdimensional vector from the plurality of category remediation hyperdimensional vectors. The possible remediation may be included in the recommended remediation based on the similarity of the possible remediation hyperdimensional vector to the category remediation hyperdimensional vector meeting a similarity threshold.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a system for threat detection and response.

FIG. 2 is a diagrammatic representation of one embodiment of a hyperdimensional computing malware classification system.

FIG. 3 is a diagrammatic representation of one embodiment of a flow in the hyperdimensional computing malware classification system.

FIG. 4 illustrates one a flow for processing an input by one embodiment of hyperdimensional computing malware classification system

FIG. 5 is flowchart illustrating one embodiment generating category classification hyperdimensional vectors.

FIG. 6 is flowchart illustrating one embodiment of generating new hyperdimensional vectors, such as sample hyperdimensional vectors or a search hyperdimensional vectors.

FIG. 7 is flowchart illustrating one embodiment of generating feature hyperdimensional vectors.

FIG. 8 is flowchart illustrating one embodiment of generating category remediation hyperdimensional vectors.

FIG. 9 is flowchart illustrating one embodiment of generating feature hyperdimensional vectors.

FIG. 10 is flowchart illustrating one embodiment of servicing a request to classify a sample.

FIG. 11 is flowchart illustrating one embodiment of servicing a search query.

FIG. 12 is a flow chart illustrating one embodiment of servicing a remediation query.

FIG. 13 is a diagrammatic representation of one embodiment of an object holding data for detection features.

FIG. 14 is a diagrammatic representation of one embodiment of a remediation map.

FIG. 15 is a diagrammatic representation of one embodiment of a computer system.

### WRITTEN DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

The present disclosure relates to hyperdimensional computing (HDC) and more particularly to HDC classification systems and methods for highly efficient classification of activity or software in computer systems. Even more particularly, some embodiments provide HDC malware classification systems and methods to classify malware. Embodiments of the present disclosure can further apply HDC to recommend actions, such as remediations, based on classifying a sample or servicing a search query.

An HDC classification system can use hyperdimensional vectors (HDVs), also referred to as hyper vectors, with large dimensionality (d) for classification and search. According to one embodiment, the HDC classification system encodes classification categories, such as malware categories, as category classification HDVs in a hyperdimensional hash table (HDHT). The category classification HDVs represent samples from the respective classification categories. When a new sample is received, the HDC classification system encodes the new sample as a new HDV (a sample HDV) and compares the new HDV to the category classification HDVs to determine the similarity of the new HDV to the category classification HDVs. The HDC classification system may, for example, classify the new sample according to the most similar classification category.

In addition, or in the alternative, to classifying samples, HDC classification systems according to the present disclosure can support searching for relevant categories, such as searching for relevant malware categories. When a search query is received, the HDC classification system encodes a new HDV (a search HDV) that represents search parameters from the search query. The HDC classification system compares the new HDV to the category classification HDVs to determine relevant categories for the new HDV. According to one embodiment, the relevant search categories for a search query include one or more of the following: the most similar category, the top x most similar categories, the k-nearest neighbor (KNN) categories, or the geographic nearest neighbor (GNN) categories in a geographic radius r.

In some embodiments, the HDC classification system returns recommended actions to take based on a new sample or search query. For example, an HDC classification system may return remediation steps for malware. An HDC classification system may, for example, include a map of actions (e.g., remediation steps) to categories and return, as recommended actions, the actions mapped to the categories determined for a sample HDV or search HDV.

In one embodiment, the HDC classification returns one or more of the following: the recommended action mapped to the most similar category, the recommended actions mapped to the top x most similar categories, the recommended actions from the k-nearest neighbor (KNN) categories, or the recommended actions for the geographic nearest neighbor (GNN) categories in a geographic radius r of the input HDV.

An HDC classification system can learn in real time. As new samples that are highly similar to existing categories are classified, the HDC classification system can incorporate the new samples into its classification processing. For example, an HDC classification system may incorporate the HDV of a newly classified sample into the category classification HDV for the category that was assigned to the sample. As another example, a user may review and confirm or change the category or actions returned for a sample or search. When the user changes or confirms the category assigned to a new sample, the category classification HDV can be updated (e.g., by aggregating the existing category classification HDV with the HDV for the new sample).

Non-limiting examples of the present disclosure further relate to malware detection and remediation. In examples, the detection of malware is achieved by evaluating detection features of objects using an HDHT representing known malware. Instead of relying on exact binary matches of signatures, the classifier can assess similarity based on patterns embodied in hyperdimensional vectors to identify malware, including malware that may have undergone code changes intended to evade traditional signature-based detection. Further, in some embodiments, the classifier can return suggested remediations for review or automated execution to remediate the threat.

Embodiments of the present disclosure provide a number of advantages when applied to malware detection. Embodiments can provide an efficient, scalable and explainable approach to threat identification. By encoding detection features into high-dimensional vectors, an HDC malware classifier generalizes across obfuscated and polymorphic threats. The high dimensionality is further robust to errors and noise, enabling more accurate detection of malicious software, even in the presence of polymorphism and code mutations. The use of high-dimensional vectors for detection reduces the likelihood of false positives and negatives, improving overall detection rates.

Embodiments can thus achieve high and accurate classification rates for potentially malicious objects, including objects that represent previously unknown threats, without the need for time consuming and computationally intensive machine learning techniques, such as support vector machines or deep neural networks, though some embodiments may be used in conjunction with such machine learning techniques or binary or linear signature matching.

An HDC classification system can be trained to classify a wide range of threats using samples of the threats. According to one embodiment, the HDC classification system can be trained to classify malware using single pass learning in which the HDC classification system generates a classification model by looking at each training data point once. Further, the HDC classification system can support automated continuous learning. As new malware samples are introduced, the HDVs of the new samples can be incorporated into the system, enhancing the classification model over time. Updating the classification model can be done, in some embodiments, through vector operations without having to reevaluate the relationship of prior samples to each other. Thus, the deployed model can be updated in real time without waiting for retraining on all the datapoints. The capability to continuously learn as samples are classified provides a significant advantage in dynamic environments.

Further, by virtue of its dimensionality, an HDC malware classification system can detect and remediate a wide variety of files (PDFs, Docx, Xlsx etc.) or other objects more quickly and efficiently than could be done using traditional computational techniques. Further, embodiments can leverage HDC classification to return actionable, tailored remediations for identified threats.

The use of hyperdimensional vectors enables efficient representation and manipulation of large datasets. HDVs can represent complex data structures compactly, reducing memory overhead. In addition, an HDC classification system can handle large-scale data streams without significant degradation in performance. The memory-efficient nature of HDC can further allow deployment of a wide range of hardware, from high-performance servers to resource-constrained devices. Thus, embodiments can leverage lightweight and scalable computations to handle large-scale, real-time environments while maintaining adaptability to emerging threats while also giving an inside view of classifications. In addition, the use of HDC for malware classification is compatible with emerging technologies, including Quantum Computing and Hyper Vector Processing.

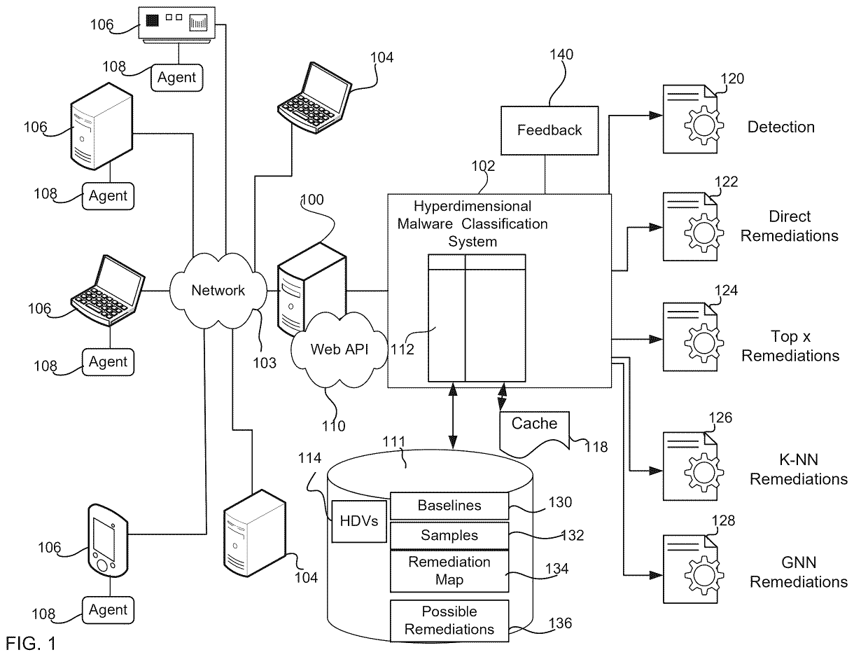

FIG. 1 is a diagrammatic representation of one embodiment of a system for threat detection and response. The architecture of FIG. 1 includes a threat detection system 100 system that includes a hyperdimensional computing malware classification system 102. A variety of client devices (e.g., desktops, mobile devices, servers, network devices) are coupled to threat detection system 100 by network 103. The client devices include unmonitored devices 104 that are not actively monitored for malware in conjunction with threat detection system 100 and monitored systems 106 that run agents 108 or otherwise collect and provide data for threat detection to threat detection system 100.

Threat detection system 100 may be a combination of interdependent components that interact to form a system for threat detection and/or remediation. Components of threat detection system 100, such as HDC malware classification system 102, can include hardware components and software implemented on hardware components of the system. In examples, threat detection system 100 may include hardware components (e.g., used to execute/run operating system (OS)), and software components (e.g., applications, application programming interfaces, modules, virtual machines, runtime libraries, etc.) running on hardware. For instance, threat detection operations, such as malware classification, and response operations may be run on a processing device such as a computer, a client device (e.g., mobile processing device, laptop, smartphone/phone, tablet, etc.) or any other electronic devices, where the components of the system may be executed on the processing device. Components of systems disclosed herein may be spread across multiple devices. For instance, files to be evaluated may be present on a client device and information may be processed or accessed from other devices in a network such as, for example, one or more server devices that may be used to perform threat detection processing and/or evaluation of a file. In one embodiment, threat detection system 100 includes one or more servers that implement HDC malware classification system 102 and provide a web application programming interface (API) 110 that provides microservices for submitting threat detection information to and receiving classifications and recommended remediations from HDC malware classification system 102. Such microservices may be used by other components running on the one or more servers or client devices that utilize the services of threat detection system 100.

HDC malware classification system 102 implements hyperdimensional computing techniques to detect malware and, in some embodiments, provide recommended remediations. More particularly, HDC malware classification system 102 implements hyperdimensional hash table (HDHT) 112 to classify files or other objects into threat categories. Malware detection may be applied, for example, to a variety of file types including bit files (e.g., 32/64 bit files), operating system files, custom built files (e.g., internal tool files), corrupted files, partial downloaded files, packed files, encrypted files, obfuscated files, third party driver files, manually manipulated binary files, Unicode files, infected files, memory snapshots, word processing files, spreadsheet files, database files, and other types of files.

Threat detection system 100 may collect data for use in training and updating the HDC malware classifier and data related to objects classified by the HDC malware classifier. Threat detection system 100 may thus include or access data storage 111, such as a database or other storage, for storing large amounts of data related to threat detection. In one example, data storage 111 comprises a robust collection of data on malware.

HDC malware classification system 102, according to one embodiment, is trained to classify objects into various categories using baseline samples that are known to belong to the categories. Data storage 111 may thus comprise baseline samples 130 used to train HDC malware classification system 102 to classify new samples. The baseline samples may be classified into categories by cybersecurity researchers, users/customers of threat detection/computer security software, business associations (e.g., other existing threat detection services or partners), third-party feeds, other classifiers (e.g., classifiers that perform binary matching or machine learning classifiers), or monitoring or evaluating: network data, executable file libraries and information on previously known malicious objects as well as benign objects, network flow observed from use of threat detection processing and products, among other examples. In some embodiments, HDC malware classification system 102 is trained on baseline samples 130 using single pass learning.

Data maintained by threat detection system 100 may be continuously updated. As new samples are classified by HDC malware classification system 102, the samples may be stored to data storage 111 as HDC classified samples 132. In some cases, a sample classified by HDC malware classification system 102 may be added to baseline samples 130 for a category based, for example, its similarity to the category. Moreover, a research team may be employed to continuously collect new samples, evaluate the samples to classify the samples, and add classified samples to baseline samples 130. As new baseline samples are added, HDC malware classification system 102 can update its classification model periodically or on the fly. According to one embodiment, HDC malware classification system 102 updates its classification model with new samples without having to reevaluate samples that were previously incorporated into the model.

A baseline sample or new sample for classification includes threat detection data for an object of interest or data from which threat detection data for the object of interest can be derived. In some embodiments, the sample includes the object of interest. The threat detection data for an object of interest comprises properties or other data from which detection features used for detecting threats can be extracted. In some embodiments, the detection features for an object of interest include data points extracted from or about the object of interest data for encoding as HDVs. The detection features may be extracted into a canonical format, such as JSON object, that HDC malware classification system 102 can easily parse to encode the detection features for the object.

As would be appreciated by one of ordinary skill in the art, a wide variety of data points can be used in malware detection and the threat detection data used by HDC malware classification system 102 may include data of various types (e.g., numeric, nominal, string or Boolean values). Non-limiting examples of data points of various data types that may be extracted as detection features.

Examples of data points with numeric values include, but are not limited to, file size, code size, OS version, image version, file version, number, product version, size of heapr, size of stackr, size of image, PE header time, section entropy, sections count.

Examples of data points with nominal values include, but are not limited to, initialize, un-initialize, entry point, subsystem, file subtype, language, file flags masks, file flags, file OS, file type, machine type PE type, section counts, DLL count, DLL functions.

Examples of data points having string values include, but are not limited to, file signatures, sequences, comments, company name, file description, internal name, legal copyright, original file, provide build, product name, special build, product version, file version, package code, product code, export DLL name, assembly version, imports, exports, certificate issuer, certificate, subject, imports, exports, section names, non-resource strings.

Examples of data points having Boolean values include, but are not limited to, address of entry point anomaly, image base anomaly, section alignment anomaly, size of code mismatch anomaly, entry point anomaly, certificate validity, certificate exception, code characteristics anomaly, count anomaly, data characteristics anomaly, data name anomaly, export exception, large number of DLLs anomaly, flag DLL name anomaly, number of functions anomaly, function name anomaly, high section count anomaly, PE magic validity.

The foregoing examples of data points are provided as non-limiting examples and a wide variety of data points can be used. A detection feature may incorporate data from multiple data points or sub-features. For instance, an embodiment may use file name, file size and the combination of file name and file size as detection features.

The detection features may include features used in the industry for threat detection by existing classifiers, features identified by cybersecurity researchers, features published by business associations (e.g., other existing threat detection services or partners) or third-party feeds, or features from other sources. According to one embodiment, a machine learning system may be applied to analyze collected data for samples to identify detection features that better distinguish between categories and the detection features identified by the machine learning system may be incorporated by HDC malware classification system 102. HDC malware classification system 102 can incorporate new data points and detection features as they are identified.

HDHT 112 comprises category classification HDVs that represent classification categories at high dimensionality (d) (e.g., dimensionality d=10000, d=20000). Classification categories are represented by corresponding category classification HDVs. HDC malware classification system 102 may thus maintain an HDV dictionary 114 that includes the category classification HDVs used to instantiate HDHT 112. For HDC malware classification system 102, the categories include categories of malware. The classification categories may also include, in some embodiments, one or more benign categories or other non-malware categories.

The category classification HDV for a classification category represents known examples of the category. For example, the category classification HDV for a category may incorporate detection feature HDVs that represent detection features from baseline samples 130 of that category. Generating a category classification HDV for a category may thus include generating baseline sample HDVs from baseline samples 130 for that category and incorporating the HDVs of the baseline samples into the category classification HDV for the category, such as through aggregation or bundling. For instance, in one example embodiment using RansomwareActivity as a classification category, HDC malware classification system 102 generates sample HDVs representing baseline samples of the RansomwareActivity category and aggregates the sample HDVs to generate the category classification HDV for the RansomwareActivity category.

A sample HDV representing a baseline sample or a sample to be classified may incorporate detection feature HDVs representing detection features extracted for the sample. Generating a sample HDV can thus include generating detection feature HDVs representing the detection features of the sample and incorporating the detection feature HDVs into the sample HDV representing the sample.

The processing and encoding of detection features may vary depending on the data being encoded (e.g., numeric values, nominal values, string, Boolean values, etc.). As an example, string sequence data may be parsed and processed as n-grams, where the n-grams from a string are encoded as random HDVs and the HDVs generated from the n-grams are bundled to generate an HDV representing the string. In another example, numeric value features may be encoded as level HDVs. Other data may be encoded as circular HDVs. In yet another embodiment, all of the detection features of a sample are treated as strings and encoded as random HDVs using n-gram encoding.

For a new sample—that is, samples to be classified by HDC malware classification system 102—HDC malware classification system 102 extracts detection features for the sample, encodes the detection features from the new sample as a sample HDV, and compares the sample HDV to the category classification HDVs of HDHT 112 that encode prior classifications for various types of threats. HDC malware classification system 102 outputs detection 120 indicating a classification category for the sample.

According to one embodiment, HDC malware classification system 102 generates similarity scores for the sample HDV with respect to the category classification HDVs and classifies the new sample based on the similarity scores. According to one embodiment, HDC malware classification system 102 returns the classification category—that is, returns the classification category corresponding to the category classification HDV that is most similar to the sample HDV—as the classification for the sample and stores the newly classified sample in classified samples 132.

In one embodiment, HDC malware classification system 102 uses the cosine similarity between the sample HDV and the category classification HDV as the similarity score for the sample HDV with respect to the category classification HDV. However, other embodiments may use additional or alternative methods of determining the similarity between the sample HDV and category classification HDV. In one embodiment of determining the similarity score for a category, HDC malware classification system 102 compares each detection feature HDV from a sample HDV to the category classification HDV for the category, determining a similarity for each detection feature HDV. Various similarity measures may be used when determining similarity for a classification category, such as, but not limited to, Hamming similarity or n-gram scores (e.g., for strings), cosine similarity for numerical values (e.g., integers, doubles, floats), or binary similarity for Booleans. For a complex object, weighted combinations of similarities can be used based on the data types the complex object holds.

HDC malware classification system 102 may apply a detection threshold for classifying samples. If the similarity score for the most similar category meets the detection threshold for the sample, the sample is categorized according to the most similar category. If no classification category meets the detection threshold, HDC malware classification system 102 may return a response that no malware was detected or other response.

As HDC malware classification system classifies samples, HDC malware classification system 102 can continuously learn. For example, when HDC malware classification system 102 detects that a sample is highly similar to a classification category based on the similarity score of the sample HDV with respect to the category classification HDV, HDC malware classification system 102 updates the category classification HDV representing the category with the sample HDV representing the new sample. In an even more particular embodiment, HDC malware classification system 102 bundles or aggregates the sample HDV with the existing category classification HDV to update the category classification HDV in HDHT 112 and HDV dictionary 114. Thus, HDC malware classification system 102 can continuously update its detection capabilities as, for example, malware evolves by incorporating new samples in the category classification HDVs of malware categories. This can allow HDC malware classification system 102 to continue to detect polymorphic malware even as it changes to avoid detection.

When a search request is received (e.g., from an agent 108, user or other source), HDC malware classification system 102 generates a search HDV representing the search request. According to one embodiment, HDC malware classification system 102 encodes each search parameter as a search feature HDV and generates a search HDV that incorporates the search feature HDVs. HDC malware classification system 102 compares the search HDV to the category classification HDVs to identify categories relevant to the search query. In one embodiment, HDC malware classification system 102 generates similarity scores for the search HDV with respect to the category classification HDVs and may identify relevant categories based on the similarity scores. Various similarity measures may be used when determining similarity for a classification category, such as, but not limited to, Hamming similarity or n-gram scores for strings, cosine similarity for numerical values (e.g., integers, doubles, floats), binary similarity for Booleans and weighted combinations of similarities.

According to one embodiment, HDC malware classification system 102 identifies the category classification HDV to which the sample HDV is most similar and returns the most similar classification category—that is, returns the classification category corresponding to the most similar category classification HDV—as a relevant category for the search query. In another example embodiment, HDC malware classification system 102 returns the top x most similar categories as relevant categories.

In one embodiment, HDC malware classification system 102 generates similarity scores for the search HDV with respect to the categories and may identify categories relevant to the search query based on the similarity scores. HDC malware classification system 102, for example, determines the category classification HDV to which the sample HDV is most similar and returns the malware category corresponding to the most similar category classification HDV (the most similar category) as the classification for the sample. In some embodiments, HDC malware classification system 102 stores new samples classified by HDC malware classification system 102 as classified samples 132. In other examples, HDC malware classification system 102 identifies KNN classification categories (the classification categories corresponding to the k nearest neighbor category classification HDVs to the search HDV), or the GNN nearest neighbor categories (the categories corresponding to category classification HDVs within a specified radius r of the search HDV) as relevant search results. When servicing a search request, classifier 214 may apply a search relevancy threshold. If no classification category meets the search relevancy threshold, HDC malware classification system 102 may return an indication that no relevant results were found. The search relevancy threshold may depend on the type of search (e.g., top x, KNN, GNN).

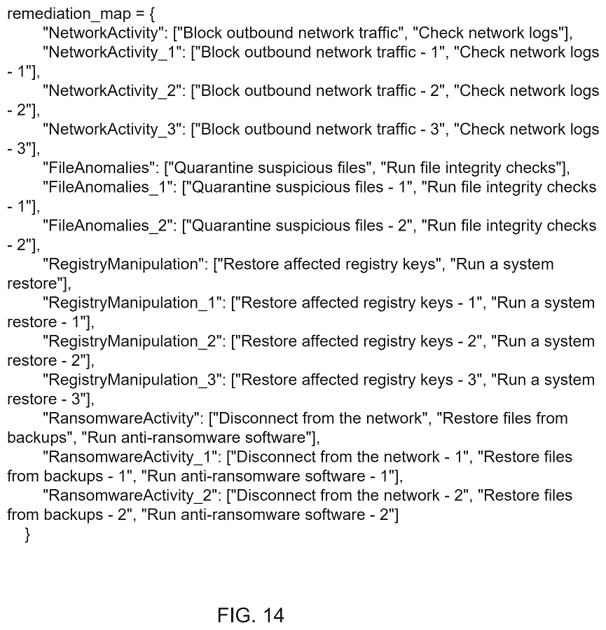

HDC malware classification system 102 of FIG. 1 includes a remediation map 134 that maps remediations to malware categories where the remediations are suggested steps for remediating malware. Thus, HDC malware classification system 102 can return recommended remediations to the requestor based on the classification categories determined for a sample or search. In some embodiments, the recommended remediations returned include remediations 122 for the top category determined for the classification request or search request—that is, the recommended remediations include remediations mapped to the category with the category classification HDV having the highest similarity to the sample HDV or search HDV. Using the example remediation map of FIG. 14, if NetworkActivity_3 category is returned as the most similar category for a sample or request, HDC malware classification system 102 can include “Block outbound network traffic—3” and “Check network logs—3” as recommended remediations.

It may be desirable in some cases to return additional or alternative remediations. Thus, malware classification system 102 may, for example, return remediations mapped to the categories having category classification HDVs with the top x similarity scores for the sample HDV or search HDV (top x remediations 124), remediations 126 mapped to the categories having the k nearest neighbor category classification HDVs to the sample HDV or search HDV (K-NN remediations 128), or the remediations mapped to categories having category classification HDVs within in a specified radius r of the sample HDV or search HDV (GNN remediations).

The detections 120 and recommended remediations are returned to the requestor. In some embodiments, a system may automatically implement the remediations. For example, when remediations are returned to an agent 108, the agent 108 may automatically implement one or more of the remediations. If none of the categories returned in response to the classification request or search request have associated remediation steps, HDC malware classification system 102 may return a default message, such as “No Remediations Found.”

A system requesting classification of a new sample or submitting a search may support remediation steps that are described differently from the remediation steps in remediation map 134. HDC malware classification system, according to one embodiment, returns remediations supported by the requestor as recommended remediations. To determine the space of possible remediations to use for responding to the request, HDC malware classification system 102 may maintain possible remediations 136 supported by various systems and can thus select from the possible remediations for a requestor when determining the recommended remediations to return. In other embodiments, a classification request or a search request includes a space of possible remediations to be used when responding to the request.

HDC malware classification system 102 can use HDHT 112 to select which remediations from the space of possible remediations supported by a requestor to return as recommended remediations. To this end, the remediation steps mapped to the categories by remediation map 134 are encoded as respective category remediation HDVs using the same hyperdimensional space that is used for the category classification HDVs. According to one embodiment, HDC malware classification system 102 generates a category remediation HDV for each category that has associated remediation steps, where the category remediation HDV for a category incorporates remediation step HDVs representing the individual remediation steps for the category. Using the example of NetworkActivity_3 from the remediation map of FIG. 14, the category remediation HDV for the NetworkActivity_3 category may thus incorporate a remediation step HDV representing “Block outbound network traffic—3” and a remediation step HDV representing “Check network logs—3”. The category remediation HDVs for the categories may be added to HDV dictionary 114 and included in HDHT 112.

According to one embodiment, HDC malware classification system 102 encodes the possible remediations for a requestor as possible remediation HDVs and determines the similarities (e.g., cosine similarities, Hamming similarities, or other similarity measures) of the possible remediation HDVs to the category remediation HDVs for the categories returned for the request. If a possible remediation HDV meets a similarity threshold with respect to at least one of the category remediation HDVs for the returned categories, HDC malware classification system 102 adds the decoded possible remediation to a set of recommended remediation steps for the request.

For example, if the requestor provides the possible remediations “Block outbound network traffic”, “Check network logs”, and “Quarantine suspicious files”, HDC malware classification system 102 encodes each possible remediation as a respective possible remediation HDV. Further, if the NetworkActivity_3 category is identified as a category for a classification request or search request, HDC malware classification system 102 determines the similarity of the possible remediation HDV for “Block outbound network traffic” to the NetworkActivity_3 remediations HDV, the similarity of the possible remediation HDV for “Check network logs” to the NetworkActivity_3 remediations HDV, and the possible remediation HDV for “Quarantine suspicious files” to the to the NetworkActivity_3 remediations HDV. If the possible remediation HDV meets the similarity threshold, HDC malware classification system 102 includes the respective possible remediation in the set of recommended remediations. If none of the possible remediation HDVs meets similarity threshold with respect to at least one of the category remediation HDVs for the categories identified for the request (e.g., the top category, top x categories, k-NN categories, GNN categories), HDC malware classification system 102 may return a default message, such as “No Remediations Found.”

In the illustrated embodiment, threat detection system 100 includes a feedback component 140 to receive feedback on classifications and remediations from reviewers, such as cybersecurity researchers or automated systems. A reviewer may review classifications assigned to classified samples 132 and remediations returned for samples 132 or in response to a search. In some embodiments, if the reviewer confirms the correctness of a sample's classification or changes the classification, the classified example 132 may be used as a baseline sample 130 for the assigned category as confirmed or corrected by the viewer. Accordingly, the category classification HDV for the assigned category can be updated by incorporating the sample HDV for the classified sample into the existing category classification HDV, such as through aggregation.

With respect to remediations, the reviewer may provide feedback such as a rating of the effectiveness of a remediation, the number of systems on which the remediation was helpful, the percentage of systems on which the remediation was tried that the remediation was helpful. In some embodiments, feedback component 140 comprises an artificial intelligence or machine learning model that analyzes the feedback on assigned categories and remediations to select which features to encode, adjust the scoring algorithm weights or update or adjust the remediations mapped to the categories.

HDHT 112 may be an in-memory model that resides in volatile memory and data to support HDHT 112 may be stored in data storage 111. Data storage 111 may include a large number of malware samples and associated remediations (e.g., millions or billions of entries). Accordingly, HDC malware classification system 102 may implement a caching layer 118 to cache data from data storage 111 for use in instantiating and manipulating HDHT 112.

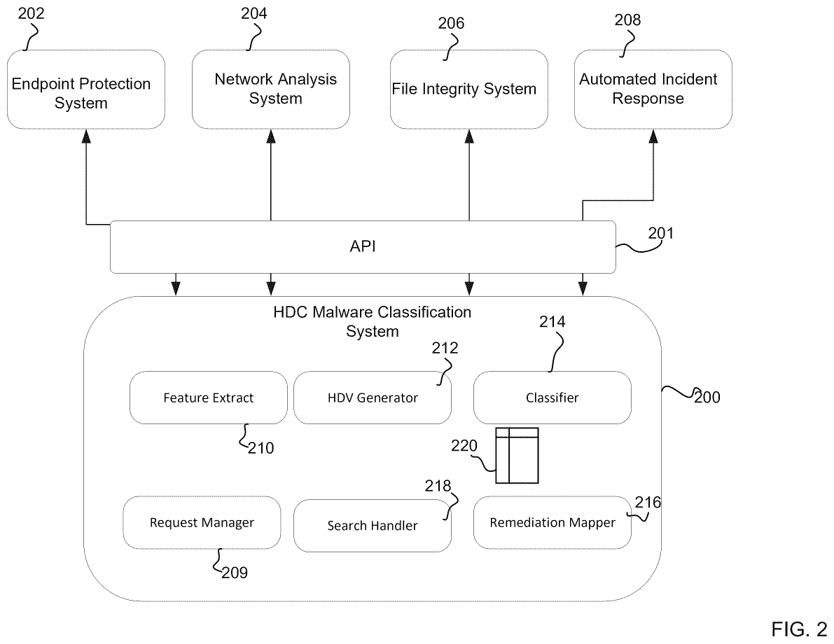

FIG. 2 illustrates one embodiment of an HDC malware classification system 200. HDC malware classification system 200, can include hardware components and software implemented on hardware components of the systems. In embodiment, HDC malware classification system 200 is embodied as software instructions stored on a non-transitory computer readable medium, where the instructions are executable to implement HDC malware classification system 200.

An interface 201 (e.g., an API) is provided to allow other threat detection, threat response, or other cybersecurity systems to submit classification and search requests to and receive classifications and remediations from HDC malware classification system 200. Examples of systems that may leverage HDC malware classification system 200 include, but are not limited to an endpoint protection system 202 that protects workstations, mobile devices, servers, etc. that access an entity's network, a network analysis system 204 that monitors and optimizes network performance of the entity's network, a file integrity system 206 that monitors critical files of the entity, and an automated network response system 208 that automates incident detection and remediation. Each system may use HDC malware for different or overlapping purposes. For example, in one embodiment, endpoint protection system 202 uses HDC malware classification system 200 for malware detection, network analysis system 204 uses HDC malware classification system 200 to detect anomalous network behavior, file integrity system 206 HDC malware classification system 200 to detect file anomalies, and automated network response system 208 uses HDC malware classification system 200 to recommend remediation steps for detected incidents.

HDC malware classification system 200 includes request manager 209, feature extractor 210, an HDV generator 212, a classifier 214 and a search handler 218. Classifier 214 and remediation mapper 216 utilize a HDHT 220 that includes category classification HDVs representing classification category and category remediation HDVs representing remediations mapped to classification categories.

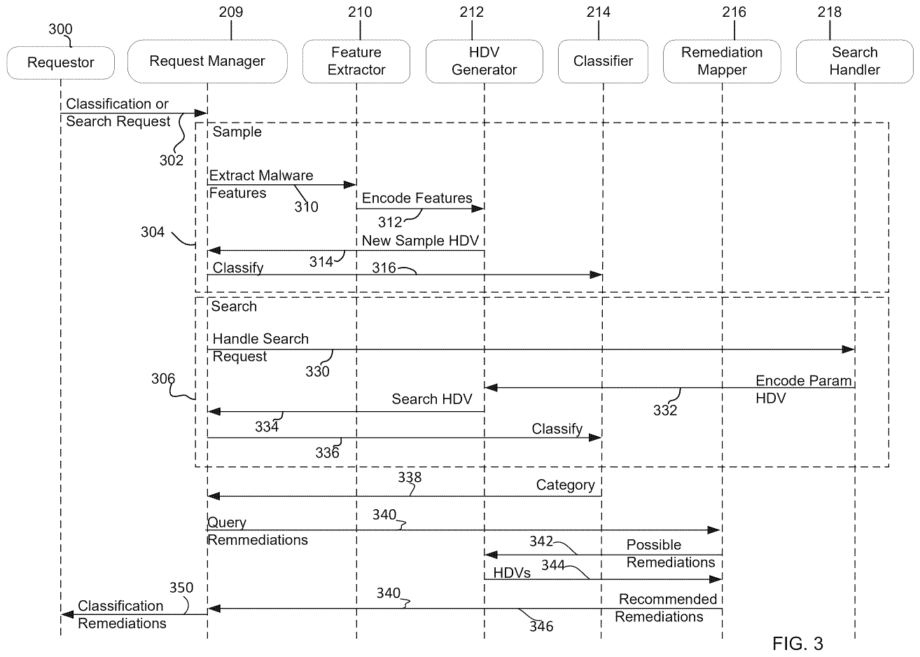

One embodiment of HDC malware classification system 200 servicing a request (e.g., a classification request or a search query) is illustrated in FIG. 3. As illustrated in FIG. 3, a requestor 300 submits request 302 to HDC malware classification system 200. If request 302 is a classification request, HDC malware classification system 200 implements classification request processing 304. If request 302 is a search request, HDC malware classification system 200 implements search request processing 306. The request may, in some embodiments, include a list of possible remediations supported by requestor 300.

A classification request is a request to classify a sample and may include the file or other object to be classified and related data. In one embodiment, the classification request includes threat detection data for the object of interest or data from which threat detection data for the object of interest can be derived. The threat detection data for the object of interest comprises properties or other data from which detection features can be extracted.

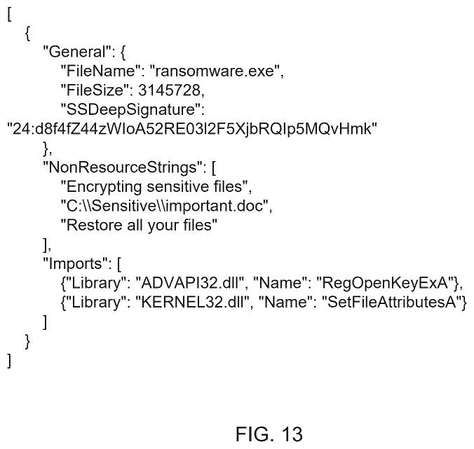

For a classification request, request manager 209 makes a call 310 to feature extractor 210 to extract detection features for the object of interest. Feature extractor 210 extracts the detection features for the sample and formats them according to format consumable by HDV generator 212. In one embodiment, detection features are passed to HDV generator 212 as a JSON object or other object from which the detection features can be parsed for encoding. One example of a JSON object holding detection features is illustrated in FIG. 13.

Feature extractor 210 makes a call 312 to HDV generator 212 to encode the detection features and passes the detection features to HDV generator 212. HDV generator 212 encodes the detection features as detection feature HDVs using the same dimensionality as HDHT 220 and incorporates the detection feature HDVs generated for the sample into a new sample HDV for the sample. HDV generator 212 sends a response 314 to request manager 209, passing the sample HDV to request manager 209. Request manager 209 then makes a call 316 to classifier 214 to classify the sample, passing the sample HDV to classifier 214.

For a search request, request manager 209 makes a call 330 to search handler 218 to handle the search request and passes the search request to search handler 218. Search handler 218 extracts the search parameters from the search query as search features and makes a call 332 to HDV generator 212 to generate a search HDV, passing the search features to HDV generator 212. HDV generator 212 encodes each of the search as a search feature HDV of the same dimensionality as HDHT 220 and generates a search HDV that incorporates the search feature HDVs. HDV generator 212 then generates a response 334 to request manager 209 and passes the search HDV to request manager 209. Request manager 209 makes a call 336 to classifier 214 to return categories that match the search request and passes the search HDV to classifier 214.

Classifier 214 processes the received HDV (e.g., sample HDV or search HDV), comparing the received HDV to the category classification HDVs of HDHT 220 to determine the similarity of the received HDV to the classification categories. In one embodiment, classifier 214 uses the cosine similarity between the received HDV and the category classification HDV as the similarity score for the received HDV with respect to the category classification HDV. However, other embodiments may use additional or alternative methods of determining the similarity between the received HDV and category classification HDV.

In one embodiment of determining the similarity score for a category, classifier 214 compares each feature HDV from the received HDV to the category classification HDV for the category, determining a similarity for each detection feature HDV and generates an overall similarity score for the received HDV with respect to the category based on the similarity scores determined for the feature HDVs with respect to the category classification HDV. Various similarity measures may be used when determining similarity for a classification category, such as, but not limited to, Hamming similarity, n-gram scores, cosine similarity, or binary similarity based on data type. For a complex object, weighted combinations of similarities (e.g., Hamming similarities, n-gram scores, cosine similarities, binary similarities) can be used based on the data types the complex object holds.

For a classification request, classifier 214 may apply a detection threshold for detecting malware. When classifying a sample, if the similarity score for the most similar classification category meets the detection threshold, the sample is categorized according to the most similar classification category and classifier 214 returns the most similar category as the classification for the sample. If no malware category meets the detection threshold, HDC malware classification system 102 may return a response that no malware was detected.

For a search request, classifier 214 returns relevant categories such as the top x most similar categories, the k-nearest neighbor (KNN) categories, or the geographic nearest neighbor (GNN) categories in a geographic radius r. When servicing a search request, classifier 214 may apply a search relevancy threshold. If no classification category meets the search relevancy threshold, classifier 214 may return an indication that no relevant results were found. The search relevancy threshold may depend on the type of search (e.g., top x, KNN, GNN).

Classifier 214 returns a response 338 that includes one or more categories determined for the classification request or search request or an indication that no category was determined (e.g., no malware was detected, no relevant category found). If classifier 214 returns one or more categories for request 302, request manager 209 generates a remediation query 340 to remediation mapper 216 that includes the one or more categories. Remediation mapper 216 determines recommended remediations based on the provided categories. In one embodiment, remediation mapper 216 includes a remediation map of remediations to categories and thus returns, as recommended remediations, the remediations mapped to the categories provided in query 340.

In another example embodiment, query 340 includes possible remediations to use in responding to request 302 and remediation mapper 216 compares the possible remediations to the remediations mapped to the classification categories provided in query 340 to determine the possible remediations to return as recommended remediations. More particularly, remediation mapper 216 uses HDHT 220 to compare possible remediation HDVs to the category remediation HDVs. To this end, remediation mapper 216 generates a call 342 to HDV generator 212 to encode the possible remediations as possible remediation HDVs for comparison to the category remediation HDVs. HDV generator 212 encodes the possible remediations as respective possible remediation HDVs using the same dimensionality as HDHT 220 and generates a response 344 to pass the possible remediation HDVs to remediation mapper 216.

Remediation mapper 216 compares the possible remediation HDVs returned by HDV generator 212 with the category remediation HDVs for the categories included in query 340 to determine the similarities of the possible remediation HDVs to the category remediation HDVs. If a possible remediation HDV meets a similarity threshold with respect to at least one of the category remediation HDVs, the possible remediation represented by that possible remediation HDV can be included in the set of recommended remediations. Thus, the recommended remediations may include remediation steps selected from a space of possible remediations supported by the requestor.

Remediation mapper 216 generates a response 346 to pass the recommended remediations or an indication that no remediations were found to request manager 209. Request manager 209 generates a response 350 to return to requestor 300 the detected categories and recommended remediations or indications that no categories or remediations were found. In some embodiments, requestor 300 automatically executes the recommended remediations.

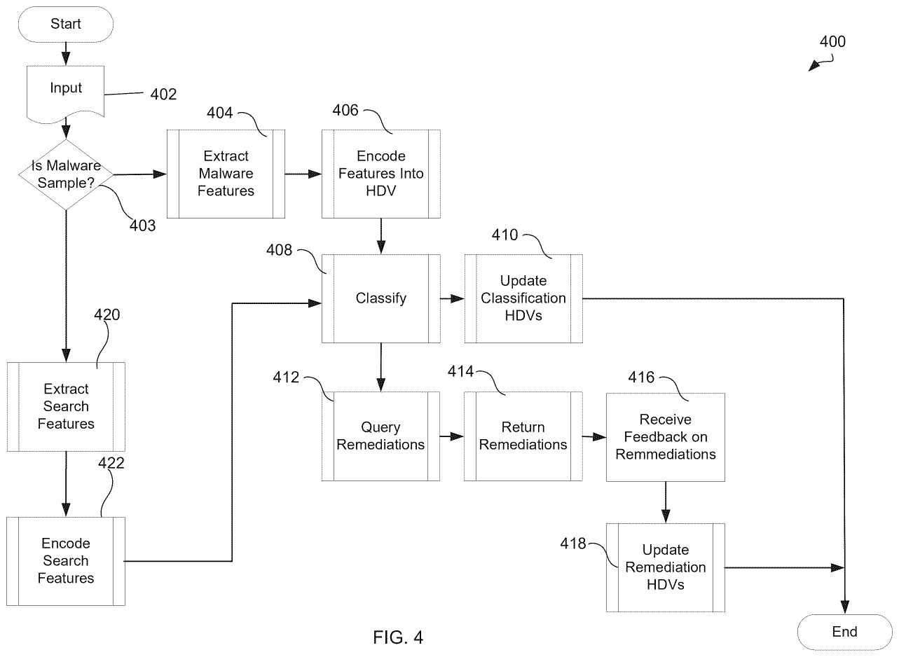

FIG. 4 illustrates one embodiment of a flow 400 for servicing a request (e.g., a classification request or a search query). Flow 400 may be implemented using software, hardware or a combination of software and hardware. In some embodiments, flow 400 may be embodied as computer code on a non-transitory computer medium, where the code is translatable by a processor to perform steps of flow 400. Flow 400 may be performed by an exemplary system such as HDC malware classification system such as HDC malware classification system 102 or HDC malware classification system 200 or by any application or service that may include implementation of malware detection processing as described herein. However, flow 400 is not limited to such examples.

Flow 400 begins when an input 402 to be processed using hyperdimensional malware classification is received. If input 402 is a malware sample (as determined at step 403), the malware sample is processed at step 404 to extract detection features. At step 406, a d-dimensional sample HDV is generated that encodes the detection feature. At step 408, the d-dimensional sample HDV is classified by comparing the d-dimensional sample HDV to category classification HDVs to determine the similarity of the sample HDV to the category classification HDVs. The sample can be classified, in one embodiment, according to the category for which the sample HDV and category classification HDV have the highest similarity. If the sample HDV is highly similar to the category classification HDV with the highest similarity (e.g., based on a learning similarity threshold, for example), the category classification HDV is updated at step 410 to incorporate the sample HDV. For example, the category classification HDV and sample HDV may be aggregated. Thus, the category classification HDV can be updated using a standard vector operation without having to reevaluate previous samples of the category.

At step 412, the classification category assigned to the sample is used to query remediations and, at step 414, recommended remediations are returned. At step 416, feedback on the recommended remediations may be received. Non-limiting examples of feedback for a remediation include a rating of the effectiveness of a remediation, the number of systems on which the remediation was helpful, or the percentage of systems on which the remediation was tried that the remediation was helpful. In some embodiments, an artificial intelligence or machine learning model analyzes the feedback on the remediations assigned to malware categories and, at step 418, updates the remediations mapped to one or more malware categories and, hence, the category remediation HDVs for those malware categories.

If input 402 is a search request that includes a search query, search parameters are extracted as search features at step 420 and, at step 422, a d-dimensional search HDV is generated that encodes the search features. At step 408, the d-dimensional search HDV is compared to the d-dimensional category classification HDVs categories relevant to the search request, such as, but not limited to, the most similar category, the top x most similar categories, KNN categories or GNN categories.

The relevant categories determined for the search query are used, at step 412, to query remediations and, at step 414, recommended remediations are returned. At step 416, feedback on the recommended remediations is received. In some embodiments, an artificial intelligence or machine learning model analyzes the feedback on the remediations assigned to malware categories and, at step 418, updates the remediations mapped to one or more malware categories and, hence, the category remediation HDVs for those malware categories.

FIG. 4 is merely an illustrative example, and the disclosed subject matter is not limited to the ordering or number of steps illustrated. Embodiments may implement additional steps or alternative steps, omit steps, or repeat steps.

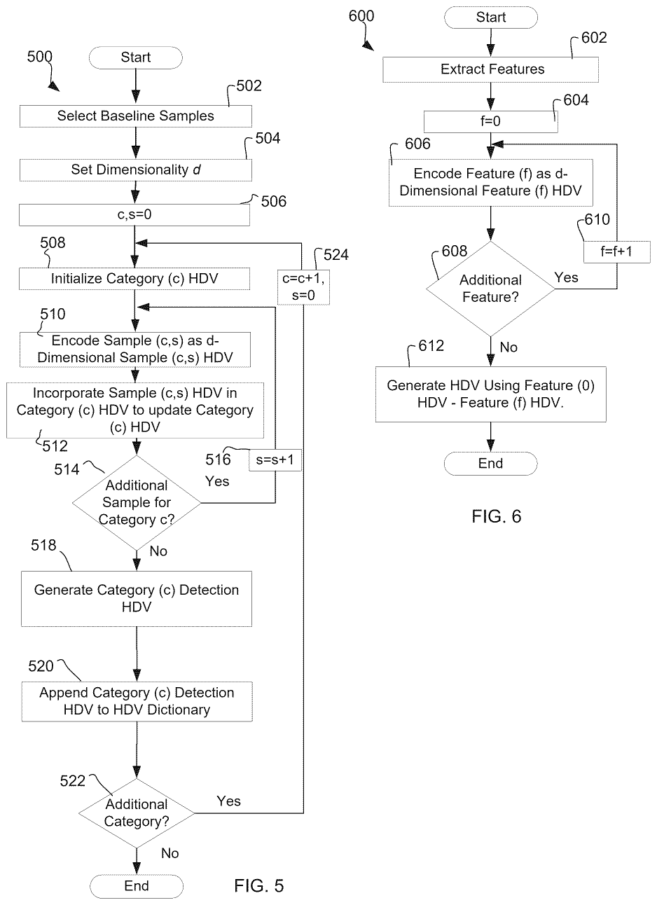

FIG. 5 is a flowchart illustrating one embodiment of a method 500 for encoding classification categories as category classification HDVs. Method 500 may be implemented using software, hardware or a combination of software and hardware. In some embodiments, method 500 may be embodied as computer code on a non-transitory computer medium, where the code is translatable by a processor to perform steps of method 500. Method 500 may be performed by an exemplary system such as HDC malware classification system such as HDC malware classification system 102 or HDC malware classification system 200 or by any application or service that may include implementation of malware detection processing as described herein. However, method 500 is not limited to such examples.

A knowledgebase of baseline samples can be built where the baseline samples are known examples of the classification categories to be represented in an HDHT. At step 502, baseline examples for the categories to be trained can be selected. At step 504, a dimensionality (d) for a hyperspace is selected. In some embodiments, the same dimensionality (d) is used for the various HDVs generated and used for malware detection, search and remediation recommendation. Preferably (d) is at least 1000 and, even more preferably, at least 10,000.

Generating the category classification HDVs can be an iterative process that iterates over categories and samples. Thus, at step 506, iterative encoding can be initialized. While illustrated using loops in FIG. 5, categories or samples may be processed in parallel or according to other processing schemes.

At step 508, a d-dimensional category HDV is initialized for the category. At step 510, the first sample for the first category is encoded as a d-dimensional sample HDV. Using the example malware categories of FIG. 14, step 512 encodes a first sample for the “Network Activity” category. At step 512, the sample HDV is incorporated in the category HDV for the category. In one embodiment, the sample HDV is aggregated into the category HDV to update the category HDV by performing an element-wise addition in place.

At step 514, a determination is made whether there is an additional baseline sample for the category to be encoded. If so, the next baseline sample is selected (step 516) (e.g., the next baseline example of the Network Activity category is selected), encoded as a d-dimensional baseline sample HDV (step 510) and incorporated into the category HDV to update the category HDV. This process can be repeated to encode any number of baseline samples for the category.

If there are no additional samples for the category, control passes to step 518 and a category classification HDV for the category is generated where the category classification HDV for the category incorporates the sample HDVs generated from the baseline samples of the category. According to one embodiment, the category HDV is normalized to produce the category classification HDV.

At step 520, the category classification HDV is added to a dictionary of category classification HDVs for the HDHT (e.g., added to HDV dictionary 114 of FIG. 1) indexed for example, by category name.

At step 522, a determination is made whether there is an additional category for which a category classification HDV is to be encoded and, if so, the next category is selected and encoding for the category initialized (step 524). The process of encoding category classification HDVs can be performed for each classification category (e.g., malware) to be represented in the HDHT.

FIG. 5 is merely an illustrative example, and the disclosed subject matter is not limited to the ordering or number of steps illustrated. Embodiments may implement additional steps or alternative steps, omit steps, or repeat steps.

FIG. 6 is a flowchart illustrating one embodiment of a method 600 for encoding a sample HDV or search HDV. Method 600 may be implemented using software, hardware or a combination of software and hardware. In some embodiments, method 600 may be embodied as computer code on a non-transitory computer medium, where the code is translatable by a processor to perform steps of method 600. Method 600 may be performed by an exemplary system such as HDC malware classification system such as HDC malware classification system 102 or HDC malware classification system 200 or by any application or service that may include implementation of malware detection processing as described herein. However, method 600 is not limited to such examples.

At step 602, features are extracted. For example, various data points can be extracted for a sample and mapped to detection features. Using the example of FIG. 13, which illustrates one embodiment of an object holding an example set of detection features, a feature extractor extracts the file name, the file size, an SSDeepSignature of the file, non-resource strings from the file, and Imports (functions called by the file, including the name of the function and the library name). For a search request, search parameters are extracted as search features.

Encoding features may be an iterative process and, at step 604, iterative feature encoding for the sample or search is initialized. While illustrated using a loop in FIG. 6, features may be processed in parallel or according to other processing schemes.

At step 606, a selected feature is encoded as d-dimensional feature HPV (e.g., detection feature HPV or search feature HPV). The encoding used may depend on the type of feature encoded (e.g., string, numerical) and whether the feature values are cyclical. In some embodiments, all the features are treated as string values and encoded using random HPV encoding. At step 608, a determination is made whether there is an additional feature to be encoded and if so, the next feature is selected (step 610) and encoded as a d-dimensional feature HDV (step 606).

At step 612, a sample HDV or search HDV that incorporates the feature HDVs is generated. According to one embodiment, generating the sample HDV or search HDV comprises bundling the feature HDVs for the sample or search into the sample HDV or the search HDV. Bundling the feature HDVs, according to one embodiment, creates an HDV that is maximally similar to the bundled HDVs. The bundled HDV may be normalized and returned as the sample HDV or search HDV.

FIG. 6 is merely an illustrative example, and the disclosed subject matter is not limited to the ordering or number of steps illustrated. Embodiments may implement additional steps or alternative steps, omit steps, or repeat steps.

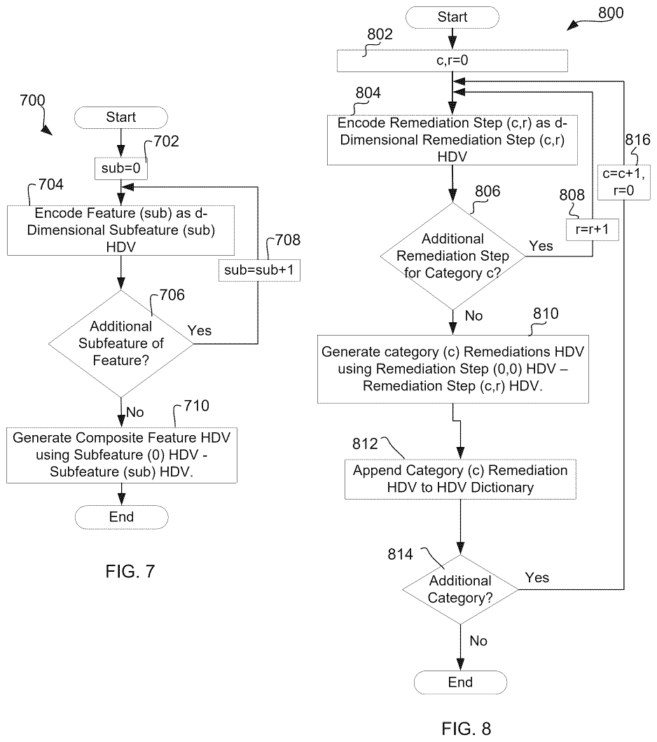

In some cases, a feature is a composite feature that includes sub-features. FIG. 7 is a flowchart illustrating one embodiment of a method 700 for encoding a composite feature that includes sub-features. The composite feature being encoded may itself be a sub-future of a composite feature. Method 700 may be implemented using software, hardware or a combination of software and hardware. In some embodiments, method 700 may be embodied as computer code on a non-transitory computer medium, where the code is translatable by a processor to perform steps of method 700. Method 700 may be performed by an exemplary system such as HDC malware classification system such as HDC malware classification system 102 or HDC malware classification system 200 or by any application or service that may include implementation of malware detection processing as described herein. However, method 700 is not limited to such examples.

Encoding sub-features may be an iterative process and, at step 702, iterative sub-feature encoding for a feature is initialized. While illustrated in a loop in FIG. 7, sub-features may be processed in parallel or according to other processing schemes.

At step 704, a selected sub-feature is encoded as d-dimensional feature HPV (e.g., detection feature HPV or search feature HPV). The encoding used may depend on the type of sub-feature encoded (e.g., string, numerical) and whether the feature values are cyclical. In some embodiments, all the sub-features are treated as string values and encoded using random HPV encoding. At step 706, a determination is made whether there is an additional sub-feature to be encoded and if so, the next sub-feature is selected (step 708) and encoded as a d-dimensional feature HDV (step 708).

At step 710, a feature HDV that incorporates the feature HDVs of the sub-features is generated for the composite feature. According to one embodiment, generating the feature HDV for the composite feature comprises bundling the feature HDVs for the sub-features into a combined HDV. Bundling the feature HDVs, according to one embodiment, creates a resulting HDV that is maximally similar to the bundled feature HDVs. The resulting HDV may be normalized and returned as the feature HDV for the composite feature.

FIG. 7 is merely an illustrative example, and the disclosed subject matter is not limited to the ordering or number of steps illustrated. Embodiments may implement additional steps or alternative steps, omit steps, or repeat steps.

To provide an example of one embodiment of generating a sample HDV using the features of FIG. 13, the features illustrated in FIG. 13 are extracted for the sample file “rasomware.exe” (step 602) and feature encoding is initialized (step 604). Processing passes to encoding a first feature (step 606), in this example a General feature. Since General contains sub-features, sub-feature encoding is initialized (step 702) for encoding sub-features of General and a first sub-feature is encoded (step 704). For instance, “rasomware.exe” is encoded as a file_name_hdv detection feature HDV. As there are additional sub-features of General to be encoded (step 706), the next sub-feature is selected (step 708) and encoded (step 704). For example, “3145728” is encoded as a file_size_hdv detection feature HDV. Similarly, “24:d8f4fZ44zWIoA52RE03l2F5XjbRQIp5MQvHmk” is encoded as ssdeepsignature_hdv detection feature HDV. At step 710, file_name_hdv, file_size_hdv, and ssdeepsignature_hdv are bundled and normalized to generate a general_features_hdv detection feature HDV.

As there are additional features to be encoded for the sample (step 608), the next feature, NonResourceStrings, is selected (step 610) and the NonResourceStrings feature encoded as a non_resource_strings_hdv detection feature HDV (step 606). Each non-resource string listed in NonResourceStrings may be treated as an independent detection feature and, as such, sub-feature encoding is initialized (step 702) for NonResourceStrings. A first sub-feature of NonResourceStrings is encoded (step 704). For instance, “Encrypting sensitive files” is encoded as a first nonresourcestring_hdv detection feature HDV (step 704). As there are additional sub-features of NonResourceStrings to be encoded (step 706), the next sub-feature is selected (step 708) and encoded (step 704). For example, “C: \\Sensitive\\important.doc” is encoded as a second nonresourcestring_hdv detection feature HDV (step 704). Similarly, “Restore all your files” is encoded as a third nonresourcestring_hdv detection feature HDV. At step 710, the first nonresourcestring_hdv, second nonresourcestring_hdv and third nonresourcestring_hdv are bundled and normalized to generate the non_resource_strings_hdv detection feature HDV.

As there is still an additional feature to be encoded for the sample (step 608), the next feature, Imports, is selected (step 610) and the “Imports” feature encoded as an imports_hdv detection feature HDV (step 606). According to one embodiment, each import (library, function pair) is treated as a sub-feature and, as such, sub-feature encoding is initialized (step 702) for encoding the sub-features of Imports. The first import sub-feature is encoded (step 704). Here, the first import has further sub-features. Accordingly, a further sub-feature encoding is initialized (step 702) to encode the sub-features of the first import sub-feature. A first sub-feature of the first import sub-feature is selected and encoded. For instance, “ADVAPI32.dll” is encoded as a library_hdv detection feature HDV. As the first import sub-feature has an additional sub-feature (step 706), the next sub-feature is selected (step 708) and encoded (step 704). For instance, “RegOpenKeyExA” is encoded as a name_hdv detection feature HDV. At step 710, the library_hdv and name_hdv for the first import sub-feature are bundled and normalized to return a first import_hdv feature detection HDV.

Returning to the Imports feature level, as there is an additional sub-feature of the imports feature (step 706), the next sub-feature is selected (step 708) and encoded (step 704). For instance, the second import listed under Imports is encoded as a second import_hdv. Here, the second import has further sub-features. Accordingly, a further sub-feature encoding is initialized (step 702) to encode the sub-features of the second import sub-feature. A first sub-feature of the second import is selected and encoded. For instance, “KERNEL32.dll” is encoded as a library_hdv detection feature HDV (step 704). As the second import sub-feature has an additional sub-feature (step 706) the next sub-feature is selected (step 708) and encoded (step 704). For instance, “SetFileAttributesA” is encoded as a name_hdv detection feature HDV. At step 710, the library_hdv and name_hdv for the second import sub-feature are bundled and normalized to return a second import_hdv feature detection HDV. Returning to the Imports feature level again, the first import_hdv and second import_hdv can be bundled and normalized to generate the imports_hdv detection feature HDV.

At step 612, general_features_hdv, non_resource_strings_hdv, and imports_hdv are bundled and normalized to generate the sample HDV for the sample represented by FIG. 13.

FIG. 8 is a flowchart illustrating one embodiment of a method 800 for encoding a remediation map. Method 800 may be implemented using software, hardware or a combination of software and hardware. In some embodiments, method 800 may be embodied as computer code on a non-transitory computer medium, where the code is translatable by a processor to perform steps of method 800. Method 800 may be performed by an exemplary system such as HDC malware classification system such as HDC malware classification system 102 or HDC malware classification system 200 or by any application or service that may include implementation of malware detection processing as described herein. However, method 800 is not limited to such examples.

Generating category remediation HDVs can be an iterative process that iterates over categories and remediations. Thus, at step 802, iterative remediation encoding can be initialized. While illustrated using a loop in FIG. 8, categories or remediations may be processed in parallel or according to other processing schemes.

At step 804, a first remediation for a first category is encoded as a d-dimensional remediation step HDV. Using the example categories of FIG. 14, step 804 encodes “Block outbound network traffic” for the “Network Activity” category. At step 806, a determination is made whether there is an additional remediation to be encoded for the category. If so, the next remediation for the category (e.g., “Check network logs”) is selected (step 808) and encoded as a d-dimensional remediation step HDV (step 804). This process can be repeated to encode all the remediations for the category as d-dimensional remediation step HDVs.

If there are no additional remediations to be encoded for the category, control passes to step 810 and the category remediation HDV for the category is generated where the category remediation HDV for the category incorporates the remediation step HDVs generated for the category.

According to one embodiment, the remediation step HDVs generated for the category are bundled and normalized to return the category remediation HDV. At step 812, the category remediation HDV is added to the HDV dictionary.

At step 814, a determination is made whether there are any additional categories for which remediations are to be encoded. If so, the next category is selected and remediation encoding initialized for the category (step 816). Remediation encoding can be performed for each category to which remediations are mapped.

FIG. 8 is merely an illustrative example, and the disclosed subject matter is not limited to the ordering or number of steps illustrated. Embodiments may implement additional steps or alternative steps, omit steps, or repeat steps.

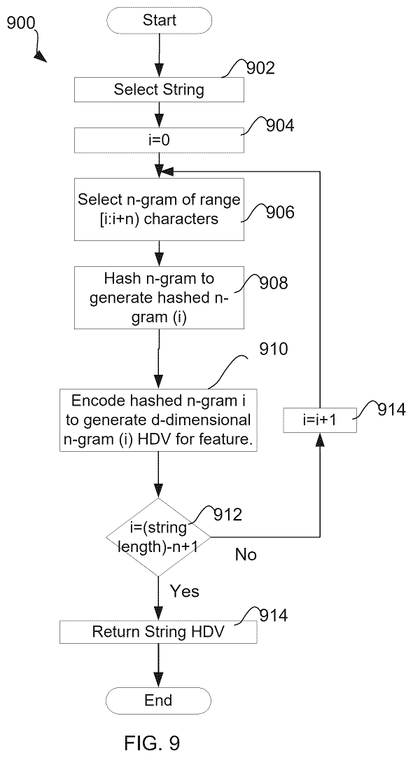

Some features have strings for values and, in some embodiments, all the features used for detection or search are treated as strings for encoding. FIG. 9 is a flowchart illustrating one embodiment of a method 900 for encoding a string value as an HDV. Method 900 may be implemented using software, hardware or a combination of software and hardware. In some embodiments, method 900 may be embodied as computer code on a non-transitory computer medium, where the code is translatable by a processor to perform steps of method 900. Method 900 may be performed by an exemplary system such as HDC malware classification system such as HDC malware classification system 102 or HDC malware classification system 200 or by any application or service that may include implementation of malware detection processing as described herein. However, method 900 is not limited to such examples.

At step 902, a string is selected for encoding and, at step 904, encoding is initialized. In method 900, the string is broken up into overlapping n-grams and the n-grams are encoded. At step 904 iterative n-gram encoding is initialized. While illustrated as a loop, n-grams may be encoded in parallel or according to other processing schemes.

At step 906, the characters for the n-gram are selected for encoding. For i=0 and n=3, the first three characters of the string are selected as the n-gram. At step 908, the n-gram is hashed using cryptographic hashing, such as SHA-256 or other suitable hashing algorithm and, at step 910, the hash of the n-gram is used as the seed to generate a random HDV for the n-gram using a hyperspace of the configured dimensionality (e.g., d=10000, d=20000). Using the hash of the n-gram as the seed helps ensure deterministic coding such that the same input gives the same output.

At step 912, a determination is made whether there is an additional n-gram to encode for the string. If so, processing moves to the next n-gram (step 914) and control returns to step 906. Thus, each n-gram from a string can be encoded as a respective n-gram HDV. The n-gram HDVs can be bundled and the resulting HDV normalized to generate a string HDV.

FIG. 9 is merely an illustrative example, and the disclosed subject matter is not limited to the ordering or number of steps illustrated. Embodiments may implement additional steps or alternative steps, omit steps, or repeat steps.

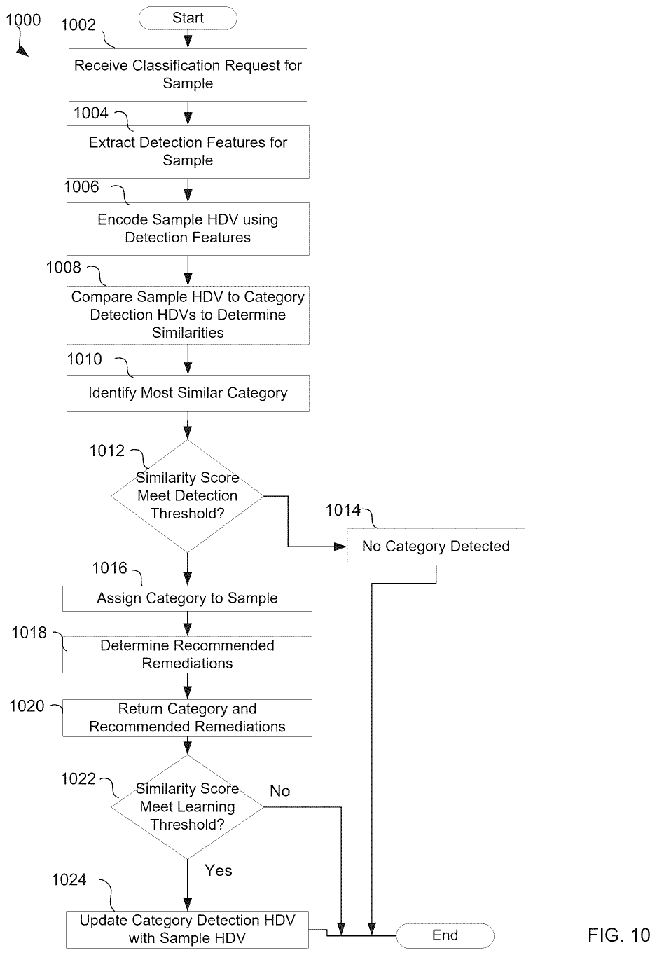

FIG. 10 is a flowchart illustrating one embodiment of a method 1000 for detecting malware. Method 1000 may be implemented using software, hardware or a combination of software and hardware. In some embodiments, method 1000 may be embodied as computer code on a non-transitory computer medium, where the code is translatable by a processor to perform steps of method 1000. Method 1000 may be performed by an exemplary system such as HDC malware classification system such as HDC malware classification system 102 or HDC malware classification system 200 or by any application or service that may include implementation of malware detection processing as described herein. However, method 1000 is not limited to such examples.

At step 1002, a classification request is received from a requestor to classify a sample. At step 1004, detection features are extracted for the sample. At step 1006, the detection features are encoded as d-dimensional feature HDVs and the feature HDVs are used to generate a d-dimensional sample HDV for the sample.

At step 1008, the sample HDV is compared to category classification HDVs in an HDHT and a similarity score is determined for each category. In one embodiment, the similarity score is the cosine similarity between the sample HDV and the category classification HDV. However, other embodiments may use additional or alternative methods of determining the similarity between the sample HDV and category classification HDV.

In one embodiment of determining the similarity score for a category, the malware classification system compares each detection feature HDV from the sample HDV to the category classification HDV for the category to determine a similarity for each detection feature HDV and generates an overall similarity score for the sample HDV with respect to the category based on the similarity scores determined for the detection features HDVs with respect to the category. Various similarity measures may be used when determining similarity for a classification category, such as, but not limited to, Hamming similarity, n-gram score, cosine similarity, or binary similarity. For a complex object, weighted combinations of similarities can be used based on the data types the complex object holds.

At step 1010, the category with the greatest similarity to the sample HDV is identified. At step 1012, a determination is made whether the similarity score of the most similar category meets a detection threshold. If not, an indication of “no malware detected” or the like may be returned (step 1014). If the similarity score of the most similar sample meets a detection threshold, the sample can be classified according to that category (1016).

At step 1018, recommended remediations are determined. In one embodiment, remediations mapped in a remediation map to the most similar category (the category identified in step 1010) are selected as the recommended remediations mapped and returned as the recommended remediations for the classification request. In other embodiments, the remediations mapped to other potentially relevant categories, such as the top x most similar categories, the k-nearest neighbor (KNN) categories, or the geographic nearest neighbor (GNN) categories in a geographic radius r, are selected as recommended remediations.

At step 1020, the category assigned to the sample and recommended remediations are returned. If no remediations are found for the assigned category, an indication that no remediations were found can be returned.

A sample HDV that is highly similar to a category, but not identical to any of the sample HDVs incorporated in the category HDV, may represent a mutation of known malware, such as an evaluation of polymorphic malware. It may therefore be desirable to incorporate highly similar samples for classification in order to continue to detect the malware as it mutates or evolves. To this end, a learning threshold may be applied such that highly similar new samples can be added to the categories to which they are similar for classifying other samples. At step 1022, a determination is made whether the similarity score meets a learning threshold. If so, the category classification HDV for the most similar category can be updated (step 1024). According to one embodiment, the category classification HDV and the sample HDV are aggregated to update the category classification HDV. Thus, the category classification HDV can be updated for highly similar new samples as they are classified using simple vector operations. This ability to update on the fly with similar samples can facilitate the continued accurate detection of malware, even in the presence of polymorphism and code mutations.

FIG. 10 is merely an illustrative example, and the disclosed subject matter is not limited to the ordering or number of steps illustrated. Embodiments may implement additional steps or alternative steps, omit steps, or repeat steps.

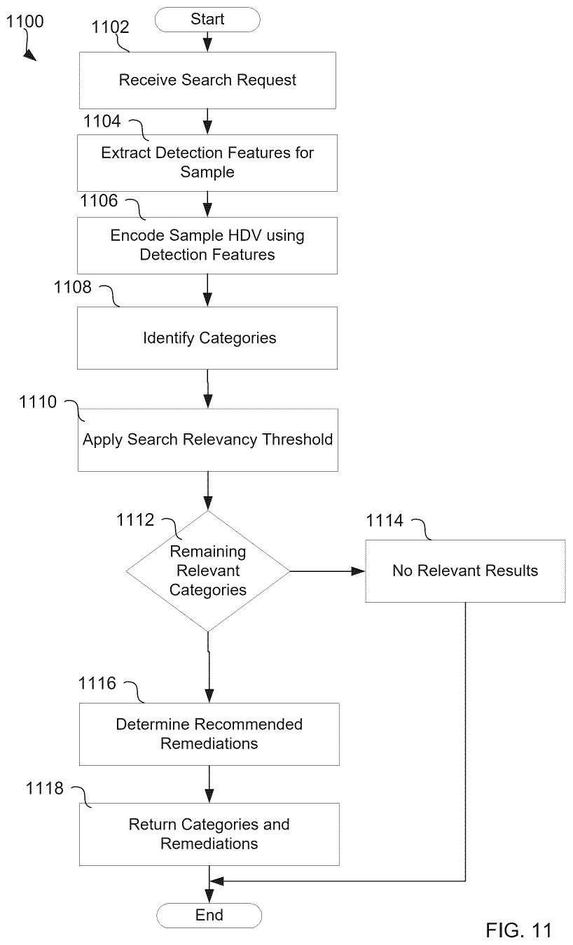

FIG. 11 is a flowchart illustrating one embodiment of a method 1100 for servicing a search request. Method 1100 may be implemented using software, hardware or a combination of software and hardware. In some embodiments, method 1100 may be embodied as computer code on a non-transitory computer medium, where the code is translatable by a processor to perform steps of method 1100. Method 1100 may be performed by an exemplary system such as HDC malware classification system such as HDC malware classification system 102 or HDC malware classification system 200 or by any application or service that may include implementation of malware detection processing as described herein. However, method 1100 is not limited to such examples.

At step 1102, a classification request is received from a requestor to classify a sample. At step 1104, search parameters are extracted from the search query as search features. At step 1106, the search features are encoded as d-dimensional feature HDVs and the feature HDVs are used to generate a d-dimensional search HDV for the search query.

At step 1108, candidate categories are determined for the search query using the search HDV and category classification HDVs. According to one embodiment, a similarity score is determined for each category and the most similar category or the top x most similar categories are identified as candidate categories for the search query. In one embodiment, the similarity score for a category is the cosine similarity between the search HDV and the category classification HDV. However, other embodiments may use additional or alternative methods of determining the similarity between the search HDV and category classification HDV. In one embodiment of determining the similarity score for a category, the malware classification system compares each search feature HDV from the search HDV to the category classification HDV for the category to determine a similarity for each search feature HDV and generates an overall similarity score for the search HDV with respect to the category based on the similarity scores determined for the search feature HDVs with respect to the category. Various similarity measures may be used when determining similarity for a classification category, such as, but not limited to, Hamming similarity, n-gram score, cosine similarity, or binary similarity. For a complex object, weighted combinations of similarities can be used based on the data types the complex object holds.

Various similarity measures may be used when determining the similarity between the search HDV and a category classification HDV, such as, but not limited to, the cosine similarity between the search HDV and the category classification HDV or Hamming similarity between the search HDV and the category classification HDV. In some embodiments, multiple metrics may be used and combined. For example, in one embodiment, each search feature HDV incorporated in the HDV can be compared to the category classification HDV for a category and a Hamming similarity determined for each search feature HDV that represents a string detection feature and a cosine similarity determined for each search feature that represents a numerical search feature. The Hamming similarities for string search features and the cosine similarities for the numerical search features can be aggregated, in some cases weighted by feature, to generate an overall similarity score for a category.

In addition, or in the alternative, a KNN search can be performed to identify the k nearest neighbor category classification HDVs to the search HDV and the categories corresponding to the k nearest neighbor category classification HDVs (the KNN categories) identified as relevant categories. As another example, the category classification HDVs in a radius r about the search HDV can be determined and the corresponding categories (GNN categories) determined as candidate categories.

In some embodiments, the categories identified at step 1108 are used as the relevant categories for the search query. In another embodiment, a search relevancy threshold is applied at step 1110 to the candidate categories identified at step 1108. The search relevancy threshold may depend on the type of search (e.g., top x, KNN, GNN). In one embodiment, the similarity scores for the categories identified at step 1108 are compared to a threshold similarity score and if a category does not meet the search similarity threshold, the category is not included in the relevant results. If no category meets the search relevancy threshold (e.g., as determined at step 1112), an indication that no relevant results were found for the search query can be returned (step 1114).

At step 1116, recommended remediations are determined for the categories determined to be relevant to the search query. In one embodiment, remediations mapped in a remediation map to the relevant categories are selected as the recommended remediations and returned as the recommended remediations. At step 1118, the categories relevant to the search query and recommended remediations are returned. If no remediations are found for the relevant categories, an indication that no remediations were found can be returned to the requestor.

FIG. 11 is merely an illustrative example, and the disclosed subject matter is not limited to the ordering or number of steps illustrated. Embodiments may implement additional steps or alternative steps, omit steps, or repeat steps.

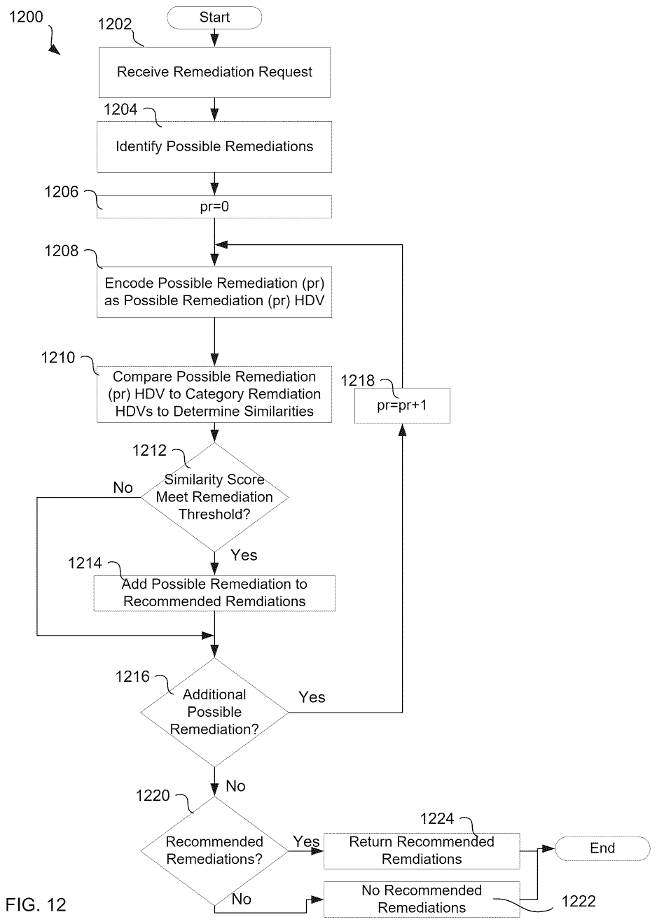

As discussed, an HDC malware classification system can return remediations mapped to malware categories as recommended remediations. However, in some cases, it may be desirable to return other remediations. For example, a requestor may support a different set of possible remediations from the remediations in the remediation map. FIG. 12 is a flowchart illustrating one embodiment of a method 1200 for determining recommended remediations from a set of possible remediations. Method 1200 may be implemented as an embodiment step 1018 or step 1116. Method 1200 may be implemented using software, hardware or a combination of software and hardware. In some embodiments, method 1100 may be embodied as computer code on a non-transitory computer medium, where the code is translatable by a processor to perform steps of method 1200. Method 1200 may be performed by an exemplary system such as HDC malware classification system such as HDC malware classification system 102 or HDC malware classification system 200 or by any application or service that may include implementation of malware detection processing as described herein. However, method 1200 is not limited to such examples.

At step 1202, a remediation query is received. The remediation query identifies one or more malware categories, such as categories determined responsive to a classification request or a search query. At step 1204, a set of possible remediations for servicing the classification request or search query is identified. In some embodiments, the possible remediations are provided by the requestor with the classification request or search query and included in the remediation query. In other embodiments, a system may store possible remediations for requestors and, at step 1204, retrieve the possible remediations for the appropriate requestor.

At step 1206, possible remediation encoding and testing is initialized. While illustrated using loops in FIG. 12, possible remediations may be processed in parallel or according to other processing schemes.

At step 1208, a possible remediation from the set of possible remediations is encoded as a respective d-dimensional possible remediation HDV vector. At step 1210, the possible remediation HDV is compared to the category remediation HDVs of each category included in the remediation query. Various similarity metrics may be used, such as cosine similarity, Hamming similarity, other similarity metrics or combinations thereof.

At step 1212, a determination whether the possible remediation meets a remediation similarity threshold is made. As one example, a determination can be made whether the cosine similarity of the possible remediation HDV and a category remediation HDV is >0.5. If the possible remediation HDV meets the remediation similarity threshold for any of the categories included in the remediation query, the possible remediation is added to a list of recommended remediations (step 1214) and control passes to step 1216. If the possible remediation HDV does meet the remediation similarity threshold for at least one of the categories included in the remediation query, control passes to step 1216.

At step 1216, a determination is made whether there are any remaining possible remediations to process for servicing the remediation query. If so, the next possible remediation is selected (step 1218) and processed. If there are no possible remediations remaining to be tested for the remediation query, control passes to step 1220.

At step 1220, a determination whether any recommended remediations were identified for the remediation query is made. If no recommended remediation sere identified—for example, if the recommended remediation list is empty—an indication that no recommended remediations were found (e.g., “No Remediations Found.”) can be returned (step 1222). If recommended remediations are identified for the remediation query, the recommended remediations are returned (step 1224).

FIG. 12 is merely an illustrative example, and the disclosed subject matter is not limited to the ordering or number of steps illustrated. Embodiments may implement additional steps or alternative steps, omit steps, or repeat steps.

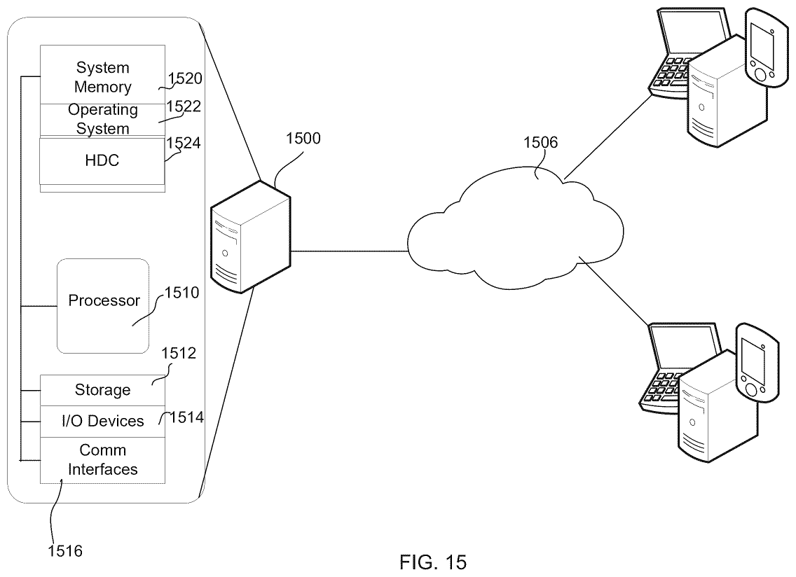

FIG. 15 illustrates one embodiment of a computer system 1500. Computer system 1500 includes a processor 1510 and memory 1520. Depending on the exact configuration and type of computing device, memory 1520 (storing, among other things, executable instructions) may be volatile (such as RAM), non-volatile (such as ROM, flash memory, etc.), or some combination of the two. Further, computer system 1500 may also include storage devices 1512, such as, but not limited to, solid state storage. Similarly, computer system 1500 may also have input device(s) and output device (I/O devices 1514) such as keyboard, mouse, pen, voice input, touch screen, speakers.

Computer system 1500 further includes communications interfaces 1516, such as a cellular interface, a Wi-Fi interface, or other interfaces.

Computer system 1500 includes at least some form of non-transitory computer-readable media. The non-transitory computer-readable readable media can be any available media that can be accessed by processor 1510 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, a number of program modules and data files may be stored in system memory 1520. While executing on processor 1510, program modules (e.g., applications, Input/Output (I/O) management, and other utilities) may perform processes including, but not limited to, one or more of the stages of the operational methods described with respect HDC malware classification system 102 or HDC malware classification system 200. In one embodiment, system memory 1520 stores an operating system 1522 and HDC malware classification code 1524 executable to provide an HDC malware classification system. Computer system 1500 may connect to various client devices by a network 1506, which may include a WAN, LAN, the Internet, or other network or combination of networks.

Some embodiments may be practiced in an electrical circuit comprising discrete electronic elements, packaged or integrated electronic chips containing logic gates, a circuit utilizing a microprocessor, or chip single chip containing electronic elements or microprocessors. For example, examples of computer system 1500 may be practiced via a system-on-a-chip (SOC) where each or many of the components of computer system 1500 may be integrated onto a single integrated circuit. Such an SOC device may include processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment on the single integrated circuit (chip).

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner or even removed or rendered as inoperable in certain cases, as is useful in accordance with a particular application. Additionally, any signal arrows in the drawings/figures should be considered only as exemplary, and not limiting, unless otherwise specifically noted.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A computer-implemented method for malware remediation, comprising:
receiving an input to be processed using hyperdimensional computing malware classification;
extracting a plurality of features based on the input;
generating a new hyperdimensional vector that represents the plurality of features; and
evaluating the new hyperdimensional vector using a hyperdimensional hash table comprising a plurality of malware category classification hyperdimensional vectors to identify a responsive malware category for the input, the plurality of malware category classification hyperdimensional vectors based on a collection of data comprising known samples of malware from a plurality of malware categories.

2. The computer-implemented method of claim 1, further comprising:
continuously automatically learning to thereby update the hyperdimensional hash table to detect polymorphic malware as the polymorphic malware evolves.

3. The computer-implemented method of claim 1, wherein the input comprises a request to classify an object and wherein the method further comprises classifying the object as a malware type according to the responsive malware category.

4. The computer-implemented method of claim 3, wherein the object is a file.

5. The computer-implemented method of claim 3, wherein the plurality of features includes detection features extracted from the object, wherein generating the new hyperdimensional vector comprises generating a plurality of detection feature hyperdimensional vectors from the detection features, and wherein the new hyperdimensional vector is generated using the plurality of detection feature hyperdimensional vectors.

6. The computer-implemented method of claim 3, wherein evaluating the new hyperdimensional vector using the hyperdimensional hash table to identify the responsive malware category comprises:
determining a similarity of the new hyperdimensional vector to each of the plurality of malware category classification hyperdimensional vectors; and
identifying a most similar malware category for the new hyperdimensional vector, wherein the most similar malware category corresponds to a malware category classification hyperdimensional vector, from the plurality of malware category classification hyperdimensional vectors, that has a highest similarity to the new hyperdimensional vector.

7. The computer-implemented method of claim 6, further comprising:
determining that the similarity of the most similar malware category meets a similarity threshold for learning; and
based on the determination that the similarity of the most similar malware category meets the similarity threshold, incorporating the new hyperdimensional vector into the malware category classification hyperdimensional vector corresponding to the most similar malware category.

8. The computer-implemented method of claim 1, wherein the input comprises a search query, wherein the plurality of features includes search features extracted from the search query, wherein generating the new hyperdimensional vector comprises generating a plurality of search feature hyperdimensional vectors from the search features, and wherein the new hyperdimensional vector is generated using the plurality of search feature hyperdimensional vectors.

9. The computer-implemented method of claim 8, wherein the responsive malware category comprises at least one of the following: a most similar malware category, a top x similar malware category determined for the input, a k-nearest neighbor malware category determined for the input, or a geographic nearest neighbor malware category determined for the input.

10. The computer-implemented method of claim 1, further comprising:
determining a recommended remediation associated with the responsive malware category; and
returning the responsive malware category and recommended remediation to a requestor.

11. The computer-implemented method of claim 10, wherein determining the recommended remediation comprises determining a remediation mapped to one or more of the following: a most similar malware category, a top x most similar malware category, a k-nearest neighbor malware category, a geographic nearest neighbor malware category.

12. The computer-implemented method of claim 10, wherein the hyperdimensional hash table comprises a plurality of category remediation hyperdimensional vectors based on remediations associated with malware categories from the plurality of malware categories, wherein the method further comprises receiving a possible remediation, and wherein determining the recommended remediation comprises:
generating a possible remediation hyperdimensional vector from the possible remediation; and
determining a similarity of the possible remediation hyperdimensional vector to a category remediation hyperdimensional vector from the plurality of category remediation hyperdimensional vectors, wherein the recommended remediation comprises the possible remediation based on the similarity of the possible remediation hyperdimensional vector to the category remediation hyperdimensional vector from the plurality of category remediation hyperdimensional vectors meeting a similarity threshold.

13. The computer-implemented method of claim 10, wherein the recommended remediation is automatically executable by the requestor.

14. A non-transitory, computer-readable medium storing thereon software code, the software code comprising instructions translatable by a processor by to:
extract a plurality of detection features for an object to be classified;
generate a sample hyperdimensional vector that represents the plurality of detection features extracted for the object; and
evaluate the sample hyperdimensional vector using a hyperdimensional hash table comprising a plurality of malware category classification hyperdimensional vectors to classify the object according to a malware type, the plurality of malware category classification hyperdimensional vectors based on a collection of data comprising known samples of malware from a plurality of malware categories.

15. The non-transitory, computer-readable medium of claim 14, wherein the software code further comprises instructions translatable by the processor to:
continuously automatically learn to thereby update the hyperdimensional hash table to detect polymorphic malware as the polymorphic malware evolves.

16. The non-transitory, computer-readable medium of claim 14, wherein generating the sample hyperdimensional vector comprises encoding the plurality of detection features as detection feature hyperdimensional vectors, wherein the sample hyperdimensional vector is generated using the detection feature hyperdimensional vectors.

17. The non-transitory, computer-readable medium of claim 14, wherein evaluating the sample hyperdimensional vector using the hyperdimensional hash table to classify the object according to the malware type comprises:
determining a similarity of the sample hyperdimensional vector to each of the plurality of malware category classification hyperdimensional vectors; and
classifying the object according to a most similar malware category, the most similar malware category corresponding to a malware category classification hyperdimensional vector, from the plurality of malware category classification hyperdimensional vectors, that has a highest similarity to the sample hyperdimensional vector.

18. The non-transitory, computer-readable medium of claim 17, wherein the software code further comprises instructions translatable by the processor to:
determine that the similarity of the most similar malware category meets a similarity threshold for learning; and
based on the most similar malware category meeting the similarity threshold, incorporate the sample hyperdimensional vector into the malware category classification hyperdimensional vector corresponding to the most similar malware category.

19. The non-transitory, computer-readable medium of claim 17, wherein the software code further comprises instructions translatable by the processor to:
determine a recommended remediation associated with the malware type; and
return the malware type and the recommended remediation to a requestor, wherein determining the recommended remediation comprises determining a remediation mapped to one or more of the following: the most similar malware category determined for the object, a top x most similar malware category determined for the object, a k-nearest neighbor malware category determined for the object, a geographic nearest neighbor malware category determined for the object.

20. The non-transitory, computer-readable medium of claim 17, wherein the hyperdimensional hash table comprises a plurality of category remediation hyperdimensional vectors based on remediations associated with malware categories from the plurality of malware categories, wherein the software code further comprises instructions translatable by the processor to:
receive a possible remediation to use when servicing a request;
determine a recommended remediation associated with the malware type; and
return the malware type and the recommended remediation to a requestor, wherein determining the recommended remediation comprises:
generating a possible remediation hyperdimensional vector from the possible remediation; and
determining a similarity of the possible remediation hyperdimensional vector to a category remediation vector from the plurality of category remediation hyperdimensional vectors, wherein the recommended remediation comprises the possible remediation based on the similarity of the possible remediation hyperdimensional vector to the category remediation vector from the plurality of category remediation hyperdimensional vectors meeting a similarity threshold.

21. A hyperdimensional computing system comprising:
a processor;
a memory storing a hyperdimensional hash table comprising a plurality of malware category classification hyperdimensional vectors based on a collection of data comprising known samples of malware from a plurality of malware categories; and
a non-transitory, computer-readable medium comprising software code translatable by the processor to provide a hyperdimensional malware classification system comprising:
a hyperdimensional vector generator executable to encode features as new hyperdimensional vectors;
a feature extractor executable to extract detection features for files to be classified and provide the detection features the hyperdimensional vector generator;
a search handler executable to extract search features from search queries and provide the search features the hyperdimensional vector generator; and
a hyperdimensional malware classifier executable to evaluate the new hyperdimensional vectors using the hyperdimensional hash table to classify the files and identify malware categories relevant to the search queries.

22. The hyperdimensional computing system of claim 21, wherein the hyperdimensional malware classification system further comprises:
a remediation mapper executable to determine recommended remediations for the files and recommended remediations responsive to the search queries.
